(19) United States
(12) Patent Application Publication
(10) Pub. No.: US 2016/0051083 A1
(43) Pub. Date: Feb. 25, 2016

(54) DEVICE AND METHOD FOR FROTHING A LIQUID FOOD, PARTICULARLY MILK

(71) Applicant: FRANKE KAFFEEMASCHINEN AG, Aarburg (CH)

(72) Inventors: Mariano Turi, Zurich (CH); Heinz Vetterli, Wangen (CH)

(73) Assignee: FRANKE KAFFEEMASCHINEN AG, Aarburg (CH)

(21) Appl. No.: 14/827,684

(22) Filed: Aug. 17, 2015

(30) Foreign Application Priority Data
Aug. 20, 2014 (DE) 102014216534.2

(51) Int. Cl. A47J 31/44; A23F 5/00; B01F 3/04; A47J 31/60

(52) U.S. Cl. CPC A47J 31/4485; A47J 31/60; A23F 5/00; B01F 3/04808

(57) ABSTRACT

A device for frothing a liquid food, particularly milk, having a pump for the liquid food from a reservoir, a continuous-flow heater, at least one throttle and one air supply, with the throttle and the continuous-flow heater being arranged at the pressurized side of the pump (2), and the air supply for supplying air into the flow path of the food being arranged upstream from the throttle. In a cold froth mode a flow path for the food-air mixture is pre-determinable through a throttle (4a) having a first throttle cross-section, and in a warm froth mode a flow path for the food-air mixture is through a throttle with a second throttle cross-section, arranged at the pressurized side of the pump (2), as well as through the continuous-flow heater, with the first and the second throttle cross-section being different. A method for frothing a liquid food, particularly milk, is also provided.

### INCORPORATION BY REFERENCE

The following documents are incorporated herein by reference as if fully set forth: German Patent Application No. DE 10 2014 216 534.2, filed Aug. 20, 2014.

### BACKGROUND

The method relates to a device as well as a method for frothing a liquid food, particularly a device for frothing milk.

Devices are known for frothing a liquid food, in which via a pump the liquid food is conveyed from a reservoir, with at the suction side of the pump air is introduced via an air supply.

Devices according to this general design are known for example from EP 1 593 330 B1 for generating warm milk froth and from EP 2 298 142 B1 as well as EP 2 120 656 B1 and EP 2 583 596 for optionally generating warm or cold milk froth.

### SUMMARY

The present invention is based on the objective to improve the froth quality of the foamed food.

This objective is attained in a device as well as a method according having one or more features of the invention. Preferred embodiments of the device according to the invention and the method according to the invention are described below and in the claims.

The device according to the invention is preferably embodied to execute the method according to the invention, particularly a preferred exemplary embodiment thereof. The method according to the invention is preferably embodied to be executed with the device according to the invention, particularly a preferred embodiment thereof.

The device according to the invention for frothing a liquid food, particularly milk, comprises a pump for conveying the liquid food from a reservoir, a continuous-flow heater, at least one throttle, and an air supply. The throttle and the continuous-flow heater are arranged at the pressurized side of the pump and the air supply is embodied and arranged such that air can be supplied into the flow path of the food, upstream in reference to the throttle.

Such a design is generally known from the above-mentioned publications.

It is essential that the device is embodied such that, optionally

in a warm froth mode a first flow path can be predetermined for the food-air mixture through a first throttle, arranged at the pressurized side of the pump, having a first throttle cross-section, as well as through the continuous-flow heater, or

in a cold froth mode a second flow path can be predetermined for the food-air mixture through a second throttle having a second throttle cross-section. Here, the first and the second throttle cross-section are different from each other.

At the pressurized side of the pump, at least two flow paths are provided for the food-air mixture, with the continuous-flow heater being arranged in a first of at least two parallel flow paths, and with one throttle being arranged in the second and the other throttle in a first of the parallel flow paths. This way, optionally a flow path is predeterminable for the food-air mixture through one or through the other parallel flow path.

With the device according to the invention a user can therefore optionally generate cold or warm froth of a food, with for the generation of the cold froth a different throttle cross-section being used compared to the throttle cross-section for generating the warm froth. Examinations have shown that the parameters for generating a desired froth consistency, and particularly the optimal throttle cross-section, depend on the temperature of the liquid food. With the device according to the invention here an optimization can be achieved for the froth generation, on the one side, when generating warm froth and, on the other side, when generating cold froth.

Examinations have shown that here preferably both the first and the second throttle cross-section are selected such that respectively one throttle function is implemented, i.e. that in both throttle cross-sections a tapering of the cross-section occurs in the flow path of the food-air mixture at the location of the throttle, however differently strong tapering of the cross-sections in the cold froth mode, on the one side, and in the warm froth mode, on the other side.

This way a quality of the two types of froth is yielded, both cold as well as warm, that previously could not be achieved.

In the method according to the invention for frothing a liquid food, particularly for frothing milk, the liquid food is mixed with air and optionally heated. Here it is essential that in a warm froth mode the food-air mixture is throttled with a first throttle cross-section and in a cold froth mode the food-air mixture is throttled with a second throttle cross-section, with the first and the second throttle cross-sections being different from each other. In the method according to the invention therefore, during the production of warm or cold froth, throttling occurs based on the reduction in the pipeline cross-section; however in the cold froth mode the throttle cross-section is different from the one of the warm froth mode.

This leads to the advantages listed above in the description of the device according to the invention.

Due to the fact that at the pressurized side of the pump at least two flow paths are provided for the food-air mixture, with the continuous-flow heater being arranged in a first of at least two parallel flow paths, it is achieved that only when passing through one (first) flow path the food-air mixture passes the continuous-flow heater. When generating cold froth, however, the food-air mixture is guided through a second flow path so that no passing of the continuous-flow heater occurs.

This leads to the advantage that in the cold froth mode no soiling of the continuous-flow heater occurs and that furthermore it is irrelevant if the continuous-flow heater still emits residual heat, due to its thermal mass, even in the shut-off state, because as described above in the cold froth mode the continuous-flow heater is not flown through.

Preferably, for this purpose a branching is provided in the flow path of the food-air mixture, at the pressurized side of the pump, into at least the above-described two parallel flow paths. Here, a manifold valve may be arranged in the flow path of the food-air mixture at the above-mentioned branching site so that via the manifold valve the desired flow path can easily be selected. It is also possible to provide a pipeline branching (a so-called Y-valve) and in each of the two parallel flow paths respectively one valve may be provided so that by opening one valve and closing the other valve the desired flow path can also be predetermined. The later embodiment provides the advantage that the two valves simultaneously can be embodied as throttles, i.e. each of the two valves offers the possibility to be completely closed or forming a variable, pre-determinable cross-section for the flow.

The scope of the invention also includes providing one valve and one throttle respectively in each of the two parallel flow paths, preferably one valve and one variable throttle each.

It is therefore within the scope of the invention that the device comprises the first throttle and the second throttle, with the first throttle being arranged in the first flow path and the second throttle being arranged in the second of the two parallel flow paths so that in the cold froth mode the food-air mixture is guided through the second throttle in the second parallel flow path, circumventing the continuous-flow heater, to an outlet and in the warm froth mode the food-air mixture is guided via the first throttle through the first of the two parallel flow paths and thus also through the continuous-flow heater.

A particularly high froth quality is yielded when one throttle is arranged upstream in reference to the continuous-flow heater and/or at the pressurized side of the pump. In particular, a good froth result is achieved when one throttle is arranged both upstream in reference to the continuous-flow heater as well as at the pressurized side of the pump.

In a preferred embodiment preferably both throttles are arranged at the pressurized side of the pump and the second throttle is arranged, as described above, upstream in reference to the continuous-flow heater.

Furthermore, it is advantageous for the froth quality that the air supply is arranged upstream in reference to the two throttles, preferably at the suction side of the pump. In the embodiment with the first throttle and the second throttle, accordingly the air supply is preferably arranged upstream in reference to the two throttles, particularly preferred at the suction side of the pump.

Furthermore, in order to yield high froth quality, the embodiment is advantageously realized as a gear pump.

It is within the scope of the invention that the air supply occurs actively, particularly via an air pump.

In a preferred embodiment the air supply occurs via the Venturi effect. For this purpose, the air supply comprises a respective Venturi element, which is arranged in the flow path of the food and is embodied such that via the Venturi effect, based on the flow of the liquid food, air is supplied. This passive air supply is advantageous in that no additional component, such as an air pump, is necessary.

The air supply is advantageously embodied as a variable air supply so that optionally at least two different air supply flows can be predetermined. This way, another optimization of the froth quality is possible by predetermining an optimized quantity of the air introduced. Accordingly it is therefore advantageous that the device, as described above, shows a control device, which can be connected to the variable air supply and is embodied cooperating such that via control signals of the controller different air flows can be predetermined. In this preferred embodiment therefore advantageously in the cold froth mode a different supply air flow (i.e. air volume per time) can be predetermined, compared to the supply air flow in the warm froth mode. In particularly in combination with one or more variable throttles, as described above, in this preferred embodiment therefore the parameters throttle cross-section and supply air flow can each separately be predetermined for the cold froth mode, on the one side, and for the warm froth mode, on the other side, so that for both modes an optimal froth quality can be achieved.

Advantageously the air supply shows therefore a variable, controllable air valve. Such a valve can be embodied as a valve, known per se, driven by an electric engine.

However it is particularly advantageous to embody the air valve as an intermittent air valve, because by an appropriate clocking, when predetermining the supply air flow, another increase of the froth quality is possible. The use of such an intermittent air valve is described in EP 2 298 142 B1 and occurs preferably similarly in the device according to the invention.

In another advantageous embodiment, in which the device comprises a control device as described above, the pump is connected to the controller and embodied cooperating such that via control signals the controller can optionally predetermine the flow rate of the pump. In this preferred embodiment therefore a flow rate can also be predetermined for the cold froth mode, different from the warm froth mode. This is particularly advantageous when, as described above, additionally the air supply volume and the throttle cross-section each can be predetermined for the warm froth mode, on the one side, and the cold froth mode, on the other side, because this way another optimization of the froth quality is possible.

The device according to the invention can be used for foaming different liquid foods. The device is particularly suitable for frothing milk. Frothed milk is used in a plurality of mixed drinks, particularly for coffee mixed drinks. The device according to the invention is therefore preferably a component of a coffee maker for generating coffee mixed drinks, with the coffee maker preferably comprising a brewing unit for generating the coffee, so that coffee can be dispensed together and/or temporarily off-set with milk and/or frothed mild, particularly optionally warm milk froth or cold milk froth. It is also within the scope of the invention to embody the device as an attachment, particularly for a coffee maker. Preferably the device comprises here a dispensing connector, at which a respective milk froth inlet of the coffee maker can be connected in a fluid-conducting fashion such that the milk froth generated by the device can be guided via the coffee maker to a dispensing outlet of the coffee maker.

When using liquid foods it is necessary to rinse the components the food flows through. This particularly applies to the use of milk and the application of the device in a non-private setting, particularly in the restaurant environment.

In a preferred embodiment the device therefore comprises a rinsing line, which is embodied for supplying rinsing liquid and/or steam at least to the first throttle and the continuous-flow heater. Preferably the rinsing line therefore connects upstream in reference to the first throttle and the continuous-flow heater to the flow path of the liquid food.

This way, both via the rinsing liquid and/or the steam the throttle and the continuous-flow heater can be rinsed. Here, the above-described embodiment of the throttle as a variable throttle with a variable throttle cross-section is particularly advantageous, so that optionally a rinsing throttle cross-section can be predetermined, with the rinsing throttle cross-section being greater than the first and the second throttle cross-section. This way a particularly efficient rinsing process can be yielded, because the throttle effect is reduced during the rinsing process due to the enlarged throttle cross-section. In particular, it is advantageous that during the rinsing process no throttle effect develops, i.e. the throttle cross-section must be selected such that no reduction of the line cross-section occurs in reference to the line located upstream thereof, so that an optimal flow of the rinsing agent is possible.

In particular the continuous-flow heater must be thoroughly cleaned, because due to the heating of the food-air mixture in the continuous-flow heater there is an increased risk for adhesion, particularly food residue sticking to the continuous-flow heater. Preferably, in the embodiment of the device with two parallel flow paths and a first and a second throttle, as described above, at least the throttle located in the flow path of the continuous-flow heater is embodied with a variable throttle cross-section, so that at least during the rinsing process of the continuous-flow heater it is possible to open this throttle and thus to allow efficient rinsing of the continuous flow heater.

The term throttle in the sense of this application refers to an element, which represents a reduced flow area (=the area of the throttle cross-section), which therefore represents a constriction of the cross-section of the line, in reference to the line located directly upstream in reference thereto. The flow area is preferably at least approximately circular, so that a flow area results from (diameter of the cross-sectional area of the throttle)² times pi times ¼. Other forms of the cross-section of the throttle are also within the scope of the invention.

In general, the first and the second throttle cross-section may differ only in their shape, however not in the cross-sectional area, because particularly due to non-laminar flows different shapes can lead to different throttle effects. Preferably the first and the second throttle cross-section differ from each other at least with regards to the cross-sectional area, in order to ensure different throttle effects even at laminar flows. An embodiment that can be implemented in a particularly simple technical fashion is here yielded in the first and second throttle cross-section showing the same shape, particularly being approximately circular.

Experiments have shown that preferably in the cold froth mode a larger cross-sectional area of the throttle is provided in reference to the warm froth mode.

Downstream in reference to the throttle preferably an expansion of the cross-section of the line is provided. Here, the scope of the invention includes that the distance between the constriction and the expansion of the cross-section of the line is very low, particularly less than 1 cm, further preferred less than 0.2 cm. In particular, one and/or the other throttle may be embodied as a screen. Greater distances between the constriction and the expansion of the cross-section of the line are also within the scope of the invention, preferably the distance is less than 20 cm, particularly less than 10 cm.

In an approximately circular throttle cross-section the diameter of the throttle cross-section ranges preferably from 0.5 mm to 2 mm to generate high-value froth.

The cross-sectional area of the throttle ranges preferably from 0.2 mm² to 3.14 mm².

For the generation of high-quality froth the pressure conditions generated by the cooperation of particularly the pump, the throttle arranged at the pressurized side of the pump, and the cross-section of the line and the length thereof, particularly downstream in reference to the throttle, are preferably as follows:

Preferably the pump and the throttle are embodied cooperating such that a pressure is given between the pump and the throttle ranging from 2 bar to 10 bar, particularly ranging from 3 bar to 7 bar, preferably amounting to approximately 5 bar. The pressure drops after the expansion of the cross-section of the line, downstream in reference to the throttle, preferably by at least one 1 bar, particularly at least 2 bar, further preferred by at least 3 bar.

The above-described preferred value ranges for the cross-section of the throttle and the pressure are preferably realized both in the warm froth mode as well as the cold froth mode, with the cross-section of the throttle in the warm froth mode being different from the one in the cold froth mode. Additionally, preferably in the warm froth mode a different pressure can be realized between the pump and the throttle than in the cold froth mode.

As mentioned above, the device according to the invention is particularly suited for generating milk froth. Experiments have shown that additionally coffee can also be foamed with surprisingly high quality using the device according to the invention. In particular, with the device according to the invention cold coffee can be frothed, which therefore is not heated by the continuous-flow heater, particularly circumventing the continuous-flow heater, via a parallel flow path. With the device, warm coffee can also be frothed with surprisingly high quality. Here, preferably freshly brewed warm coffee is also frothed without heating by a continuous-flow heater, particularly via a parallel flow path while circumventing the continuous-flow heater.

In particular, it is advantageous to partially froth cold or warm coffee with the device, and to store the coffee/coffee froth in a refrigerator. This way, cold coffee is available when required, which is still sufficient frothed.

### BRIEF DESCRIPTION OF THE DRAWINGS

In the following additional preferred features and embodiments are described based on exemplary embodiments and the figures. Shown are:

FIG. 1 a first example of a device with only one flow path;

FIG. 2 an exemplary embodiment according to the invention with two parallel flow paths and two throttles, and

FIG. 3 a third example with two parallel flow paths and only one throttle.

### DETAILED DESCRIPTION OF THE PREFERRED EMBODIMENTS

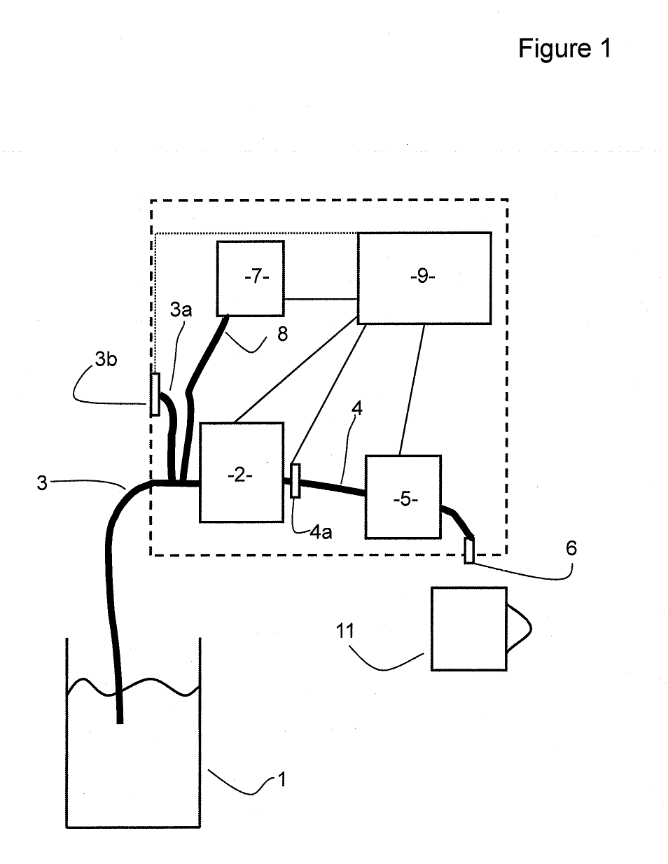

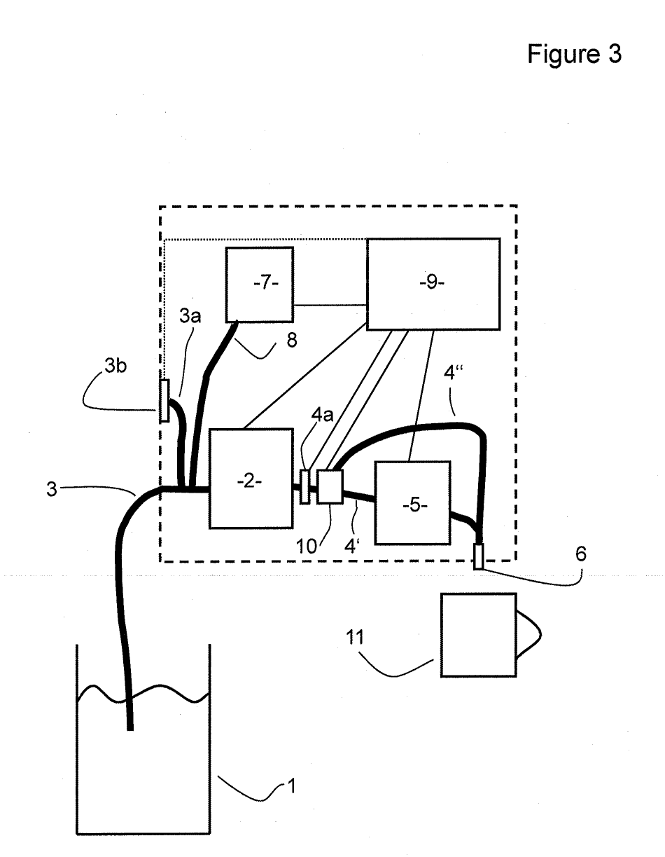

The figures show schematic illustrations, not true to scale. Identical reference characters in the FIGS. 1 and 3 mark the same or identically operating elements.

FIG. 1 shows a first example of a device. The device is embodied to froth milk, which is located in a reservoir 1. The reservoir 1 is arranged in a refrigerator (not shown).

Milk is conveyed from the reservoir 1 via a pump 2, showing a conveyance line 3 at the suction side. The device further comprises an air supply which shows an air supply line 3a and an air valve 3b.

The air valve 3b is arranged at a housing of the device, shown in dot-dash lines, so that air from the environment of the device can be suctioned in. The air supply line 3a connects at the suction side of the pump 2 to the conveyance line 3, with at the connection site a Venturi element being arranged such that when conveying milk from the reservoir 1 via the pump 2 air is supplied via the air valve 3b through the air supply line 3a of the milk into the conveyance line 3.

The pump 2 is embodied as a gear pump.

At the pressurized side of the pump, in the pressure line 4, first a throttle 4a and further downstream a continuous-flow heater 5 are arranged. Further downstream in reference to the continuous-flow heater 5 the pressure line 4 ends in an outlet 6 so that the milk froth can be dispensed into a container, such as for example a cup 11.

The throttle 4a is embodied as a variable throttle, so that via a controller 9 of the device two different cross-sections of diameters of the throttle 4a can be predetermined.

When the user now selects via a control panel (not shown) the dispensing of cold milk froth, here via the controller 9 a first cross-section of flow is adjusted for the throttle 4a, and via the pump 2 the milk-air mixture (the milk froth) is dispensed from the outlet 6 with the continuous-flow heater 5 being shut off. If the user however selects warm milk froth, via the control panel of the controller 9 a second cross-section of flow is adjusted for the throttle 4a, which is different from the first cross-section of flow, the continuous-flow heater 5 is activated and accordingly via the pump 2, warm milk froth is dispensed from the outlet 6.

In the controller 9, here the optimized parameters are saved, particularly with regards to the cross-section of the throttle 4a and the flow rate of the pump 2, on the one hand, for warm milk froth and, on the other hand, for cold milk froth, and according to the operating mode selected they are recalled and forwarded to the individual components via control signals.

In the present case, the air valve 3b is embodied as a manually operated air valve so that the user can manually implement an optimization of the air supply volume.

The cross-section of the throttle is approximately circular in the cold froth mode and in the warm froth mode and shows in the cold froth mode a diameter of 0.9 mm and in the warm froth mode a diameter of 0.7 mm. The pressure between the pump and the throttle amounts in the cold froth mode to approximately 4 bar and in the warm froth mode to approximately 5 bar. The pressure downstream in reference to the throttle amounts in both cases to approximately 0.5 bar.

The air valve may be embodied as an electrically controlled air valve and may also be connected to the controller 9 (shown by a dot-dash line). This way the air supply flow can be automatically predetermined by the controller 9 and particularly when generating warm milk froth a different air supply flow can be predetermined in reference to the generation of cold milk froth.

In another preferred variant of the exemplary embodiment the air valve 3b is embodied as an intermittent air valve according to EP 2 298 142 B1 and also connected to the controller 9 so that via the controller, using a defined clock frequency and DC (duty cycle), i.e. setting the scanning ratio, the air supply volume can be saved as another parameter, on the one hand, for the cold froth mode and, on the other hand, for the warm froth mode, and forwarded via control signals to the air valve 3b, according to the selection of the user.

In order to clean the device a hot water unit 7 is provided with a rinsing line 8, which is connected to the conveyance line 3 between the air supply line 3a and the pump 2.

In a cleaning mode, hot water is suctioned by the hot water unit 7 via the rinsing line 8 using the pump 2. For this purpose, via the controller 9 a rinsing throttle cross-section of the throttle 4a is adjusted, which shows no reduction in cross-section in reference to the pressurized line between the pump 2 and the throttle 4a. The continuous-flow heater 5 can therefore be rinsed with a high flow rate using hot water.

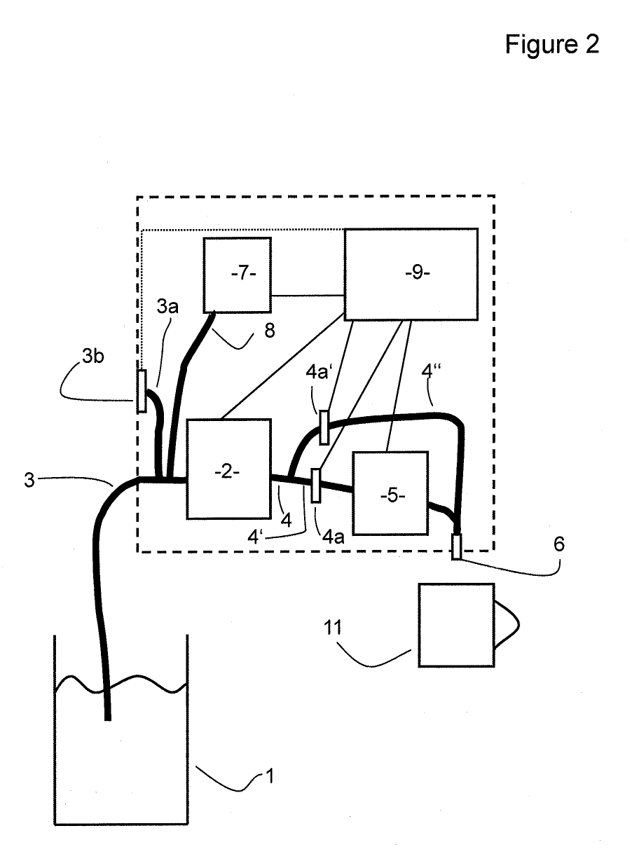

FIG. 2 shows an exemplary embodiment of a device according to the invention, which shows a similar design in reference to the device shown in the first example. In order to avoid repetitions in the following only the essential differences are discussed.

The exemplary embodiment shows two parallel flow paths.

At the pressurized side of the pump 2 the pressure line 4 splits into a first flow path 4′ and a second flow path 4″, with the first flow path 4′ and the second flow path 4″ being arranged parallel and the continuous-flow heater 5 being arranged in the first flow path 4′. The two parallel flow paths 4′ and 4″ jointly connect to the outlet 6.

The device therefore comprises a first throttle 4a and a second throttle 4a′. Both of them are embodied in the exemplary embodiment as variable throttles and connected to the controller 9. The variable throttles 4a and 4a′ allow particularly the selection of a throttle cross-section 0, i.e. they offer additionally the functionality of a valve. This way, by setting the throttle cross-section 0 for either the throttle 4a or the throttle 4a′ in one of the two parallel flow paths it can be predetermined, that for generating cold milk froth the milk-air mixture is guided, circumventing the continuous-flow heater 5, via the other throttle 4a′ and the second flow path 4″ to the outlet 6 and accordingly for generating warm milk froth, instead of the second flow path 4″, the milk-air mixture flows through the first flow path 4′ with the first throttle 4a and the continuous-flow heater 5.

Here, too, for generating cold milk froth, a different throttle cross-section is set in the first throttle 4a, compared to the predetermined throttle cross-section in the other throttle 4a′ for generating warm milk froth.

In an alternative exemplary embodiment, in each of the two parallel flow paths 4′ and 4″ a valve is arranged upstream in reference to the variable throttle, with both valves also being connected to the controller 9, so that in this case the throttles 4a and 4a′ not necessarily need to be embodied such that a throttle cross-section 0 can be predetermined, but the selection of the flow path occurs by a respective switching of the two above-mentioned valves.

The rinsing of the device occurs similar as described already for FIG. 1, with in the device according to FIG. 2 both flow paths being rinsed sequentially one after the other.

FIG. 3 shows as a third example a device, which in its design is generally equivalent to the second exemplary embodiment according to FIG. 2. Here, too, in order to avoid repetitions, only the essential differences are being discussed.

Contrary to FIG. 2, only a variable throttle valve 4a is provided and furthermore a manifold valve 10 at the split of the pressure line 4 into the first flow path 4′ and the second flow path 4″.

In the cold froth mode the manifold valve is therefore switched by the controller 9 such that the milk-air mixture is issued via the second flow path 4″. Simultaneously, as described in the first exemplary embodiment, the variable throttle 4a is set to a saved first throttle cross-section. Accordingly, in a warm froth mode the manifold valve 10 is switched such that the milk-air mixture is dispensed via the second flow path 4″ and the continuous-flow heater 5 under heating to the outlet 6, with via the controller 9 the variable throttle 4a being adjusted to a second throttle cross-section.

1. A device for frothing a liquid food, comprising:
a pump (2) for conveying the liquid food from a reservoir (1), a continuous-flow heater (5), first and second throttles (4a, 4a′), and an air supply,
at least first and second parallel flow paths (4′, 4″) for a food-air mixture are located at a pressurized side of the pump, the continuous-flow heater (5) and the first throttle (4a) having a first throttle cross-section being arranged in the first parallel flow path (4′), and the second throttle (4a′) having a second throttle cross-section being arranged in the second parallel flow path (4″), with the first and the second throttle cross-section being different from each other,
the air supply being arranged for supplying air into a flow path for the food, upstream in reference to at least one of the throttles (4a, 4a′),
wherein for the food-air mixture in a warm froth mode, the food-air mixture is directed through the first flow path (4′) through the first throttle (4a) as well as through the continuous-flow heater (5), and for the food-air mixture in a cold froth mode, the food-air mixture is directed through the second flow path (4″) through the second throttle (4a′).

2. The device according to claim 1, wherein the first throttle (4a) is arranged between the pump (2) and the continuous-flow heater (5).

3. The device according to claim 1, wherein the air supply is arranged at a suction side of the pump (2).

4. The device according to claim 1, wherein the air supply comprises a variable air supply with at least two different predetermined air supply flows.

5. The device according to claim 4, further comprising a controller (9), which controls the air supply such that in the warm froth mode air is supplied with a first air supply flow and in the cold froth mode air is supplied in a second air supply flow to the food, with the first air supply flow and the second one being different.

6. The device according to claim 1, further comprising a rinsing line (8) for supplying at least one of a rinsing liquid or steam at least to the first throttle (4a) and the continuous-flow heater (5), and first throttle (4a) comprises a variable throttle with a variable throttle cross-section, and a rinsing throttle cross-section of the first throttle is greater than the first and the second throttle cross-sections.

7. The device according to claim 1, wherein the pump (2) and both the first and second throttles (4a, 4a′) are embodied cooperating with each other such that a pressure is given between the pump (2) and the throttles (4a, 4a′) ranging from 2 bar to 10 bar.

8. A coffee maker for generating coffee-mixed drinks, comprising:
a brewing unit for generating coffee, and a device for frothing a liquid food according to claim 1.

9. A method for frothing a liquid food, comprising:
selecting a warm froth mode or a cold froth mode,
in the warm froth mode, pumping the liquid food mixed with air through a first flow path (4′) arranged at a pressurized side of a pump (2), and throttling the liquid food-air mixture along the first flow path (4′) using a first throttle (4a) having a first throttle cross-section and heating the liquid food-air mixture in a continuous-flow heater (5), and
in the cold froth mode, pumping the liquid food mixed with air through a second flow path (4″), parallel in reference to the first flow path (4″), throttling the liquid food-air mixture using a second throttle (4a′) having second throttle cross-section, wherein the first and the second throttle cross-section are different from each other.

10. A method according to claim 9, further comprising, in the warm froth mode supplying the air with a first air supply flow, and in the cold froth mode, supplying the air with a second air supply flow, with the first and the second air supply flows being different.

11. The method according to claim 9, wherein the first throttle (4a) is a variable throttle having a variable throttle cross-section, and the method further comprising, in a rinsing mode supplying at least one of water or steam through the first throttle (4a) and the continuous-flow heater (5), and in the rinsing mode, setting the variable throttle (4a) to a rinse throttle cross-section, with the rinse throttle cross-section being greater than the first and the second throttle cross-sections.

12. The method according to claim 9, wherein coffee is frothed.
